(19) United States
(12) Patent Application Publication
(10) Pub. No.: US 2024/0395231 A1
(43) Pub. Date: Nov. 28, 2024

(54) TRACKING BEATS AND DOWNBEATS OF VOICES IN REAL TIME

(71) Applicant: Lemon Inc., Grand Cayman (KY)

(72) Inventors: Yun-Ning HUNG, Culver City, CA (US); Ju-Chiang WANG, Los Angeles, CA (US); Mojtaba HEYDARI, Culver City, CA (US)

(21) Appl. No.: 18/200,924

(22) Filed: May 23, 2023

(51) Int. Cl. G10H 1/00

(52) U.S. Cl. CPC G10H 1/0008; G10H 2210/061; G10H 2210/076; G10H 2250/015; G10H 2250/235

(57) ABSTRACT

The present disclosure describes techniques for tracking beats and downbeats of audio, such as human voices, in real time. Audio may be received in real time. The audio may be split into a sequence of segments. A sequence of audio features representing the sequence of segments of the audio may be extracted. A continuous sequence of activations indicative of probabilities of beats or downbeats occurring in the sequence of segments of the audio may be generated using a machine learning model with causal mechanisms. Timings of the beats or the downbeats occurring in the sequence of segments of the audio may be determined based on the continuous sequence of activations by fusing local rhythmic information with respect to each instant segment with information indicative of beats or downbeats in previous segments among the sequence of segments.

### BACKGROUND

Techniques for audio rhythmic analysis are widely used in music, filmmaking, social media, and entertainment industries. Such techniques may be used to identify the beat, downbeat, and/or tempo in audio. Recently, the demand for audio rhythmic analysis is increasing. However, conventional techniques for audio rhythmic analysis may not be able to fulfill the needs of users due to various limitations. Therefore, improvements in audio rhythmic analysis are needed.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for tracking beats and downbeats of human voices in real time in accordance with the present disclosure.

FIG. 2 shows an example activation in accordance with the present disclosure.

FIG. 3 shows an example particle filtering inference on a 2D beat pointer state space in accordance with the present disclosure.

FIG. 4 shows an example past-informed process for two time steps which may be performed in accordance with the present disclosure.

FIG. 5 shows an example process in accordance with the present disclosure.

FIG. 6 shows an example process for tracking beats and downbeats of human voices in real time which may be performed in accordance with the present disclosure.

FIG. 7 shows an example process for tracking beats and downbeats of human voices in real time which may be performed in accordance with the present disclosure.

FIG. 8 shows an example process for tracking beats and downbeats of human voices in real time which may be performed in accordance with the present disclosure.

FIG. 9 shows an example process for tracking beats and downbeats of human voices in real time which may be performed in accordance with the present disclosure.

FIG. 10 shows an example process for tracking beats and downbeats of human voices in real time which may be performed in accordance with the present disclosure.

FIG. 11 shows an example table illustrating evaluation results in accordance with the present disclosure.

FIG. 12 shows an example computing device which may be used to perform any of the techniques disclosed herein.

### DETAILED DESCRIPTION OF ILLUSTRATIVE EMBODIMENTS

Rhythmic analysis of audio, e.g., music audio, has many applications. Music rhythmic analysis may be used to identify the beat, downbeat, and/or tempo in music audio. Music beat, downbeat, tempo, and meter tracking techniques may be important for automatic music production, analysis and/or manipulation. Deep learning-based models have been proposed for music beat, downbeat, tempo, and meter tracking. Such deep learning-based models may employ recurrent neural networks (RNN), convolutional neural networks (CNN), convolutional recurrent neural networks (CRNN), and/or temporal convolutional networks (TCN) to model beats and downbeats in music audio. Additionally, or alternatively, some music beat, downbeat, tempo, and meter tracking techniques utilize transformers and self-supervised learning to improve performance of the deep learning-based models. Such techniques are offline and largely utilize a non-causal Dynamic Bayesian Network (DBN) decoder to infer music beats and downbeats.

However, such techniques are not capable of tracking beats and downbeats of audio (e.g., human singing voices) in real time. Some beat, downbeat, tempo, and meter tracking techniques are able to perform causally for real-time applications. As one example, a sliding window technique may be applied on an offline model to predict upcoming beats in audio. This technique may lead to computational overload and may cause a lack of continuity between windows.

For many use cases, such as interactive social media gadget design, singing voice auto-accompaniment, and live performance processing, real-time singing voice beat and downbeat tracking is essential. Existing techniques are not capable of tracking beats and downbeats of human voice audio, such as a human singing voice, in real time. It is more difficult to track beats and downbeats in isolated singing voices than in full music signals (e.g., the mixture of vocals and accompaniment) for rhythmic analysis, as isolated singing voices typically lack rich percussive and harmonic profiles. Thus, applying general audio rhythmic analysis approaches to track beat and downbeat in human voice audio tracking is thus less effective.

Some offline beat and downbeat tracking techniques for isolated singing voices have been proposed to fulfill the requirements for applications such as automatic music arrangement, mix, and remix. Such techniques employ speech representations as their front-end to leverage semantic information of singing voices. Such techniques further utilize multi-head linear self-attention encoder layers, followed by an offline DBN decoder, to infer the singing beats. However, real-time processing may impose causality constraints on the system. For example, the system may only have partial data access and may have no second chance to correct previously inferred results according to the new data. Further, neural network structures need to be causal and computationally efficient. Thus, bulky transformers and massive pre-trained speech models, which are previously demonstrated to be beneficial for offline singing voice beat tracking, are not sufficient for real-time human voice (e.g., singing) beat and downbeat tracking. Accordingly, improved techniques for real-time human voice (e.g., singing) beat and downbeat tracking are desirable.

Described herein is a real time beat and downbeat tracking system for human voices, such as human singing voices. The system described herein utilizes a CRNN to model the beat and downbeat activations. The system described herein further utilizes a novel dynamic particle filtering (PF) model that leverages a variable number of particles for the inference instead of the fixed number of particles used in traditional PF approaches. The novel dynamic PF model described herein incorporates the offline inference results on all historical data into the ongoing online inference process to correct the online inference process by manipulating the number and positions of the particles. As rhythm analysis of human voices, such as human singing voices, is more robust when the past signal is accounted for, such analysis results can be an informative to improve the online inference. Furthermore, to take all substantial activations into account, it adds extra particles when there is a considerable salience happening.

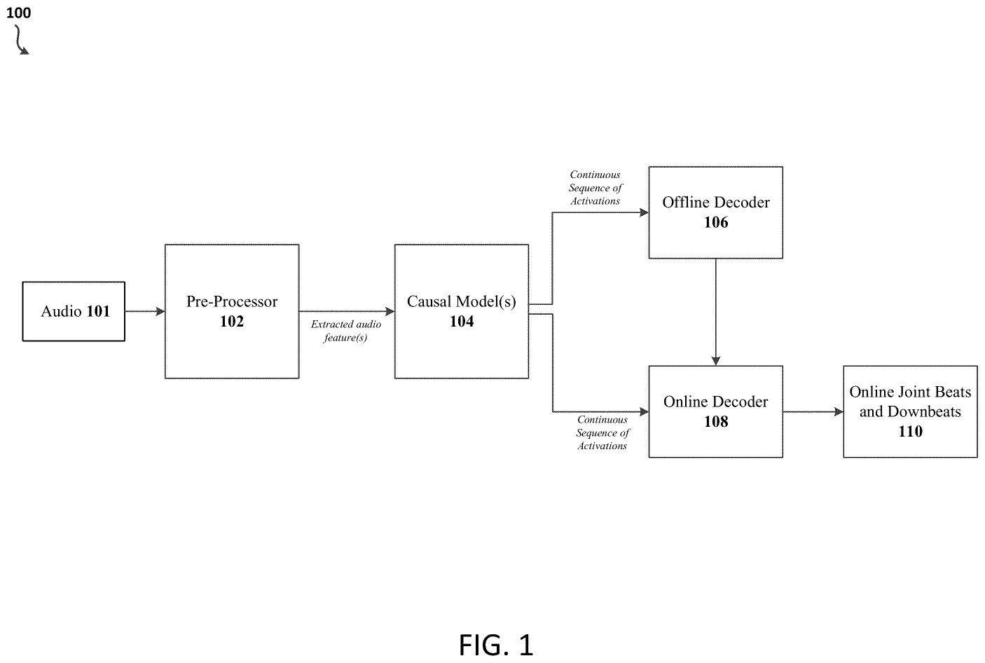

FIG. 1 illustrates an example system 100. The system 100 may be used for tracking beats and downbeats of human voices in real time. The system 100 may comprise a pre-processor 102, a causal model 104, an offline decoder 106, and an online decoder 108.

The pre-processor 102 may receive human voice audio 101. It is to be noted that the human voice audio 101 is received only when it is authorized by the owner of the human voice audio 101 to be used (including, but not limited to, receiving, processing, and so on). The human voice audio 101 may comprise a human singing voice. For example, the human voice audio 101 may be received from a microphone (e.g., a microphone included on a client device, such as a mobile phone or tablet) in real time (e.g., as the human is speaking or singing into the microphone). The human voice audio 101 may be split into a sequence of segments. Each segment may comprise any length (e.g., duration) of audio. For example, each segment may comprise two, three, four, five, six, seven, eight, nine, ten etc. seconds of the human voice audio 101.

The pre-processor 102 may extract a sequence of audio features representing the sequence of segments of the human voice audio 101. To extract the sequence of audio features corresponding to the sequence of segments of the human voice audio 101, the pre-processor 102 may extract audio features from each of the segments in the sequence of segments. For example, the pre-processor 102 may extract first audio features from the first segment in the sequence of segments, second audio features from the second segment in the sequence of segments, and so on. The audio features may comprise, for example, pitch, duration, absolute pitch distance below, absolute pitch distance above, onset position in bar, and pitch in scale. The extracted sequence of audio features corresponding to the sequence of segments of the human voice audio 101 may be input to the causal model(s) 104.

The pre-processor 102 may extract the sequence of audio features corresponding to the sequence of segments of the human voice audio 101 by generating a sequence of short-time Fourier transform (STFT) spectrograms corresponding to (e.g., representative of) the sequence of segments of the human voice audio 101. Each of the STFT spectrograms in the sequence may represent/correspond to a particular segment of the human voice audio 101. Alternatively, the pre-processor 102 may extract the sequence of audio features corresponding to the sequence of segments of the human voice audio 101 by generating a sequence of harmonic constant-Q transform (CQT) spectrograms corresponding to the sequence of segments of the human voice audio 101. Each of the harmonic CQT spectrograms in the sequence may represent/correspond to a particular segment of the human voice audio 101. Alternatively, the pre-processor 102 may extract the sequence of audio features corresponding to the sequence of segments of the human voice audio 101 by generating a sequence of Mel Spectrograms corresponding to the sequence of segments of the human voice audio 101. Each of the Mel Spectrograms in the sequence may represent/correspond to a particular segment of the human voice audio 101.

The causal model(s) 104 may receive the extracted sequence of audio features corresponding to the sequence of segments of the human voice audio 101 from the pre-processor 102. The causal model(s) 104 may comprise any machine learning model with casual mechanisms, such as a recurrent neural network (RNN) and/or a temporal convolutional neural network (TCN).

The machine learning model may be pre-trained to generate beat or downbeat activations based on audio features indicative of human voices. Training the machine learning model to generate beat or downbeat activations based on audio features indicative of human voices may comprise inputting audio features associated with various segments of training human voice audio into the machine learning model. The machine learning model may generate (e.g., output) activations associated with the various segments of training human voice audio based on the corresponding input audio features. The various segments of training human voice audio may be associated with ground truth activations. The plurality of activations may be compared to the corresponding ground truth activations. Comparing the plurality of activations to the corresponding ground truth activations may comprise comparing the plurality of activations to the corresponding ground truth activations using a binary cross entropy loss function. At least one parameter of the machine learning model may be updated based on the comparison between the plurality of activations to the corresponding ground truth activations.

The trained causal model(s) 104 may be configured to generate a sequence of activations based on the extracted sequence of audio features representing/corresponding to the sequence of segments of the human voice audio 101. The causal model(s) 104 may generate the sequence of activations in real time. The sequence of activations may be a continuous sequence of activations. The sequence of activations may be indicative of probabilities of beats or downbeats occurring in the sequence of segments. The sequence of activations may correspond to the sequence of segments of the human voice audio 101. Each activation in the sequence of activations may indicate the probability of beats and/or downbeats occurring at each time frame in a corresponding segment. The activation(s) generated for each segment may comprise one indicating the probability of beats occurring at each time frame in the segment and the other indicating the probability of downbeats occurring at each time frame in the segment. The sequence of activations from the causal model(s) 104 may be input to the offline decoder 106 and/or to the online decoder 108.

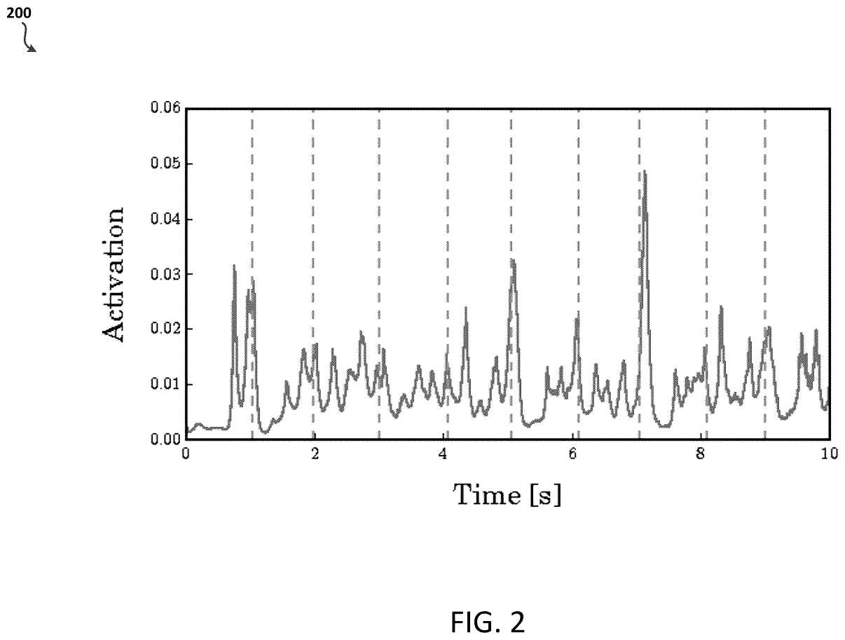

FIG. 2 is an example activation 200. The activation 200 may correspond to a particular segment in the sequence of segments of the human voice audio 101. For example, the activation 200 may correspond to a ten second segment in the sequence of segments of the human voice audio 101. The activation 200 indicates the probability of beats occurring at each time frame in the ten second segment. For example, the activation 200 includes a peak at around the seventh second. This peak indicates that a beat is most likely to occur around the seventh second. While the activation 200 indicates only the probability of beats occurring at each time frame in the ten second segment, it should be appreciated that an activation corresponding to a particular segment may additionally, or alternatively, indicate the probability of downbeats occurring at each time frame in the particular segment.

Referring back to FIG. 1, the offline decoder 106 and the online decoder 108 may receive the sequence of activations from the causal model(s) 104. The offline decoder 106 and the online decoder 108 may, in combination with one another, determine timings of the beats or the downbeats occurring in the sequence of segments of the human voice 101. The offline decoder 106 and the online decoder 108 may, in combination with one another, determine the timings of the beats or the downbeats occurring in the sequence of segments of the human voice 101 based on the continuous sequence of activations. The offline decoder 106 and the online decoder 108 may, in combination with one another, determine the timings of the beats or the downbeats occurring in the sequence of segments of the human voice 101 by fusing local rhythmic information with respect to each instant segment among the sequence of segments of the human voice audio 101 with information indicative of beats or downbeats in previous segments among the sequence of segments of the human voice audio 101. The online decoder 108 may output data indicating the online joint beats and downbeats 110. The data indicating the online joint beats and downbeats 110 may indicate the determined timings of the beats or the downbeats occurring in the sequence of segments of the human voice audio 101.

The online (e.g., salience-informed) decoder 108 may be applied to provide the local rhythmic information with respect to each instant (e.g., current) segment among the sequence of segments of the human voice audio. The online decoder 108 may generate the local rhythmic information associated with a particular segment, such as the instant segment, based only on the activation corresponding to that segment. As the online decoder 108 only considers local prediction, it may be more robust to local rhythmic fluctuations or changes. This may be helpful for tracking beats and downbeats of human voices in real time as humans may not sing consistently or well in a few regions.

In embodiments, the online decoder 108 comprises an online particle filtering decoder. Particle filtering (e.g., sequential Monte Carlo methods) comprises a set of algorithms used to solve filtering problems arising in signal processing and Bayesian statistical inference. Particle filtering uses a set of particles (e.g., samples) to represent the posterior distribution of a stochastic process given the noisy and/or partial observations. The state-space model can be non-linear and the initial state and noise distributions can take any form required. Particle filter techniques may be used to generate samples from the required distribution without requiring assumptions about the state-space model or the state distributions.

Particle filters may update their prediction in an approximate (statistical) manner. The samples from the distribution may be represented by a set of particles. Each particle may have a likelihood weight assigned to it, representing the probability of that particle being sampled from the probability density function. Weight disparity leading to weight collapse is a common issue encountered in these filtering algorithms. Weight disparity may be mitigated by including a resampling step before the weights become uneven. Several adaptive resampling criteria can be used including the variance of the weights and the relative entropy concerning the uniform distribution. In the resampling step, the particles with negligible weights are replaced by new particles in the proximity of the particles with higher weights.

The online decoder 108 may be configured to perform a cascade of two-stage Monte Carlo particle filtering. One stage may be to generate local rhythmic information for the beat tracking and the other stage to generate local rhythmic information for the downbeat tracking. However, instead of using a fixed number of particles, as seen with conventional particle filtering techniques, the online decoder 108 may perform a dynamic particle filtering technique. The dynamic particle filtering technique may leverage a variable number of particles, with the number depending on the circumstance.

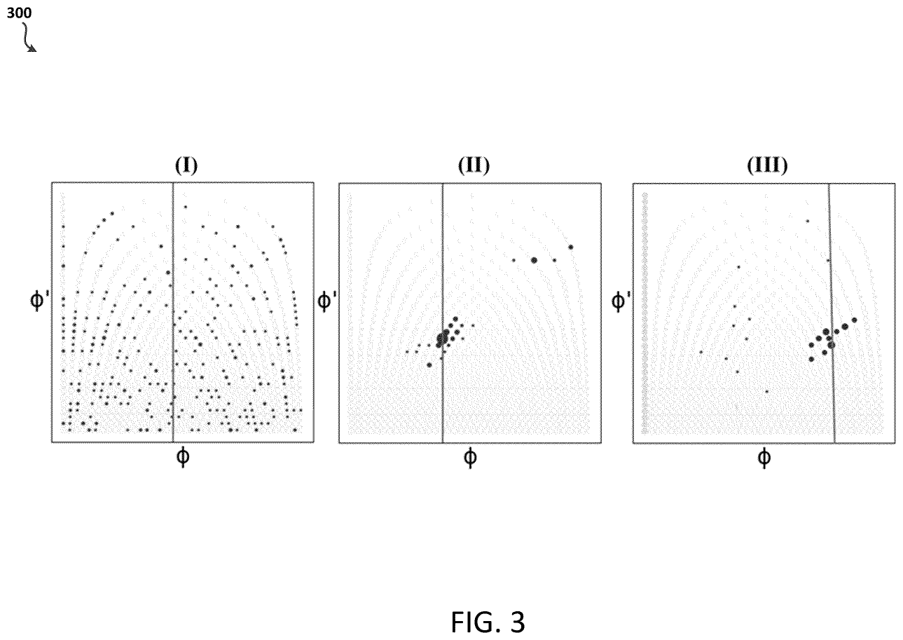

FIG. 3 is an example particle filtering process 300 for beat/tempo tracking. The process 300 may be performed, for example, by the online decoder 108. The process 300 shows the 2D beat pointer state space 300 and the particle filtering inference on it. The gray dots shown in FIG. 3 each represent a possible state, ϕ and ϕ′ represent the phase and tempo axes of the state, the black dots represent the particles, and the vertical black line represents the median of the particles along phase. The first image (e.g., image I) of FIG. 3 corresponds to the beginning of the process 300, when the particles are distributed randomly. The second image (e.g., image II) of FIG. 3 displays one of the later time steps in the process 300 when the particles are converged to a swarm which is moving forward according to the transition model. The third image (e.g., image III) displays a time step when a salience activation occurs in the beat states (e.g., the first column in the state space), but the particle swarm is in a distant position to the beat states.

The online decoder 108 may utilize the instant salient activations to gain robustness to local rhythmic fluctuation/change. In regular cases, the particle swarm may return to the beat/downbeat position at the same time when the next predominant activation is happening. However, as shown in image III of FIG. 3, the time steps of particles may be far from the beat/downbeat states when a strong beat/downbeat activation is occurring. This may be caused by either a tempo change or an inference mistake (e.g., the inference is not responsive to such salient activations). To prevent the time steps of particles from being far from the beat/downbeat states when a strong beat/downbeat activation is occurring, the online decoder 108 may add extra particles at beat/downbeat states when a strong activation is detected.

The offline (e.g., past-informed) decoder 106 may be applied to generate a prediction of a beat or a downbeat in each instant segment based on the information indicative of beats or downbeats in previous segments among the sequence of segments of the human voice audio 101. Information indicative of the prediction from the offline decoder 106 may be incorporated into the online decoder 108. The offline decoder 106 may comprise a hidden Markov model (HMM) decoder and/or a dynamic Bayesian network (DBN) decoder.

A fusion of simultaneous online and offline inferences may be used to determine the timings of the beats or the downbeats occurring in the sequence of segments of the human voice audio 101. Given a period parameter T, the offline decoder 106 may be applied every T seconds to the past data (e.g., all activations in the sequence of activations from the beginning to the present time step). The historical beat/downbeat timestamps may be used by the offline decoder 106 to extrapolate the next upcoming beats/downbeats. When the time steps of the upcoming beats/downbeats arrive, the offline decoder 106 may inject some particles at the beat/downbeat states to inform the online decoder 108 about the offline extrapolations. If the particle swarm locates in some offbeat states but the offline inference made by the offline decoder 106 suggests a beat/downbeat onset, adding the extra particles can help correct the online inference made by the online decoder 108.

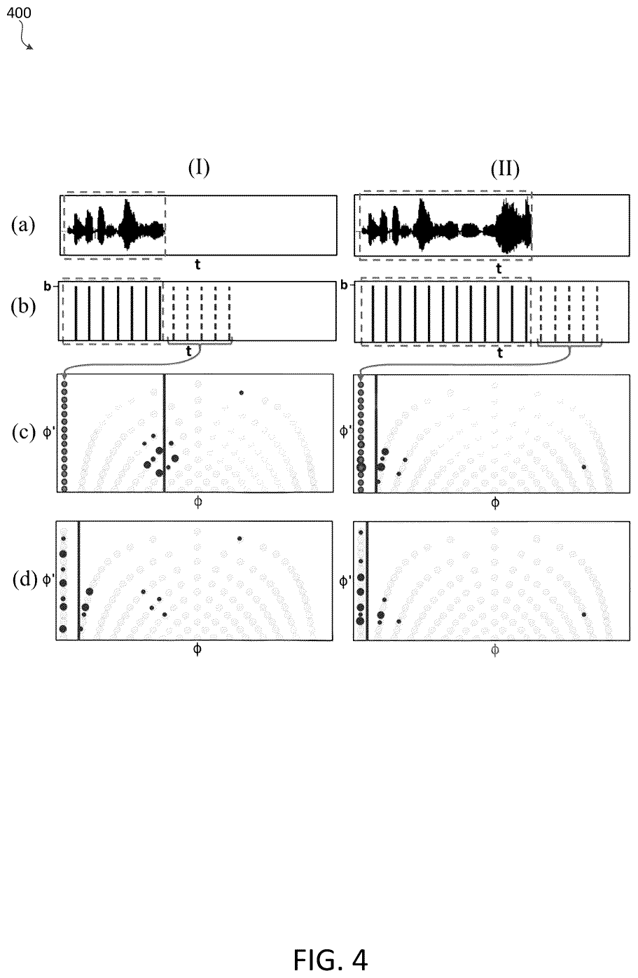

FIG. 4 demonstrates an example process 400. The process 400 may use a fusion of simultaneous online and offline inferences to determine the timings of the beats or the downbeats occurring in the sequence of segments of the human voice audio. While FIG. 4 only shows the process for using a fusion of simultaneous online and offline inferences to determine the timings of the beats occurring in the sequence of segments, it should be appreciated that the same process may be used to determine the timings of the downbeats occurring in the sequence of segments. FIG. 4 shows the process 400 for two time-steps. The first timestep is shown in the first column, while the second timestep is shown in the second column. In row (a), the streaming audio is arriving. In row (b), the solid lines represent historical beats inferred by the offline decoder 106 on existing activations. The dotted lines represent the results extrapolated from the solid lines.

In row (c), new particles are injected into the beat/tempo state space before resampling. The new particles are injected based on the extrapolations. The new particles are shown in the first column in the state space. At time step I, there is a big discrepancy between the offline extrapolations and the online particle swarm. The fact that there is a big discrepancy between the offline extrapolations and the online particle swarm is indicated by the median solid line being located far from the beat state. Adding particles shifts the beat phase significantly. At time step II, the online beat status is already corrected; thus, adding particles does not change the beat phase much. In embodiments, the same number of particles as the number of injected particles may be randomly selected and removed from the original particle pool after the resampling step to ensure the total number of particles is the same for every iteration throughout the whole inference process. Row (d) shows the phase correction after resampling.

In embodiments, the length of each segment of the sequence of segments of human voice audio (e.g., the human voice audio 101) may be padded before the above-described process is performed. If a certain duration, such as N seconds (e.g., 9 seconds) of past information, is required for offline processing, the whole audio with a length of 9 seconds may be fed into the causal model(s) to output 9 seconds of activation. However, if the whole audio is fed into the causal model(s), the causal model(s) may not be able to handle such a long segment better than a shorter segment. Alternatively, the whole audio may be split into segments (e.g., split into 3 segments, 3 seconds per segment) or split into overlapping pieces and then fed into the causal model(s) to generate multiple activations and then combine them. But if shorter segments, such as three segments each of which has a length of 3 seconds, are fed into the causal model(s), the causal model(s) may not be able to see the information from other regions.

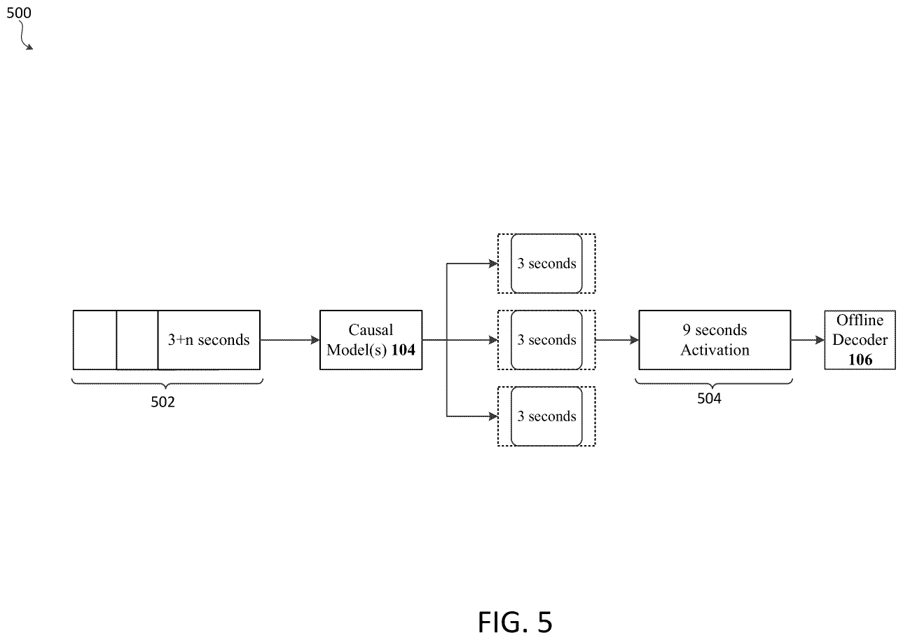

To remedy this, the length of each segment of the sequence of segments may be padded. Each segment may be padded n seconds before and after. For example, n seconds may be added to the beginning and end of each segment. FIG. 5 is an example process 500. Padded segments 502 may be input into the causal model(s) 104. Each of the padded segments 502 may comprise a three-second segment that is padded by n seconds. The padding may provide information to the causal model(s) 104. The causal model(s) 104 may use the padded segments 502 to generate three activations. The three activations may be combined. The combined activation 504 may be associated with a nine-second duration. Such padded segments provide more information to the causal model(s), which results in better performance.

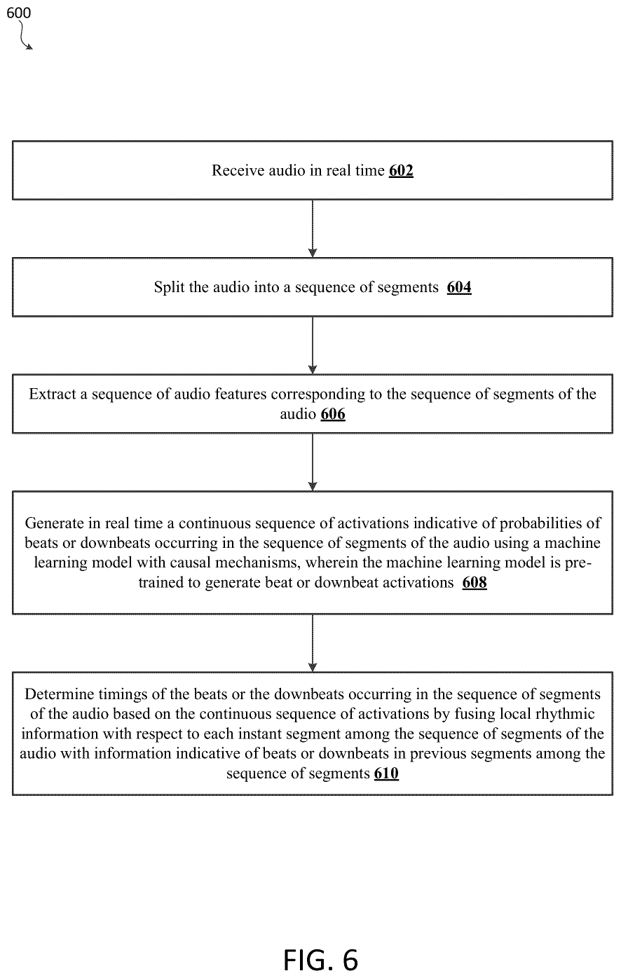

FIG. 6 illustrates an example process 600 performed by a system (e.g., system 100). The system 100 may perform the process 600 for tracking beats and downbeats of human voices in real time. Although depicted as a sequence of operations in FIG. 6, those of ordinary skill in the art will appreciate that various embodiments may add, remove, reorder, or modify the depicted operations.

At 602, audio may be received. The audio may comprise human voice audio. The audio may be received in real time. The audio may comprise a human singing voice. At 604, the audio may be split into a sequence of segments. Each segment may comprise any length (e.g., duration) of audio. For example, each segment may comprise two, three, four, five, six, seven, eight, nine, ten etc. seconds of the audio. At 606, a sequence of audio features may be extracted by a pre-processor (e.g., the pre-processor 102). The sequence of audio features may represent/correspond to the sequence of segments of the audio. To extract the sequence of audio features corresponding to the sequence of segments of the audio, audio features may be extracted from each of the segments in the sequence of segments. The audio features may comprise, for example, pitch, duration, absolute pitch distance below, absolute pitch distance above, onset position in bar, and pitch in scale. The extracted sequence of audio features corresponding to the sequence of segments of the audio may be sent to or input into one or more causal models.

At 608, a continuous sequence of activations may be generated. The continuous sequence of activations may be generated in real time. The continuous sequence of activations may be indicative of probabilities of beats or downbeats occurring in the sequence of segments of the audio. The continuous sequence of activations may be generated using a machine learning model with causal mechanisms (e.g., the causal model 104). The machine learning model may be pre-trained to generate beat or downbeat activations based on audio features indicative of human voices. Each activation in the sequence of activations may indicate the probability of beats and/or downbeats occurring at each time frame in the corresponding segment.

At 610, timings of the beats or the downbeats occurring in the sequence of segments of the human voice may be determined. The timings of the beats or downbeats may be determined based on the continuous sequence of activations by fusing local rhythmic information with respect to each instant segment among the sequence of segments of the audio with information indicative of beats or downbeats in previous segments among the sequence of segments. Data indicating the timings of the beats or the downbeats occurring in the sequence of segments of the human voice may be output.

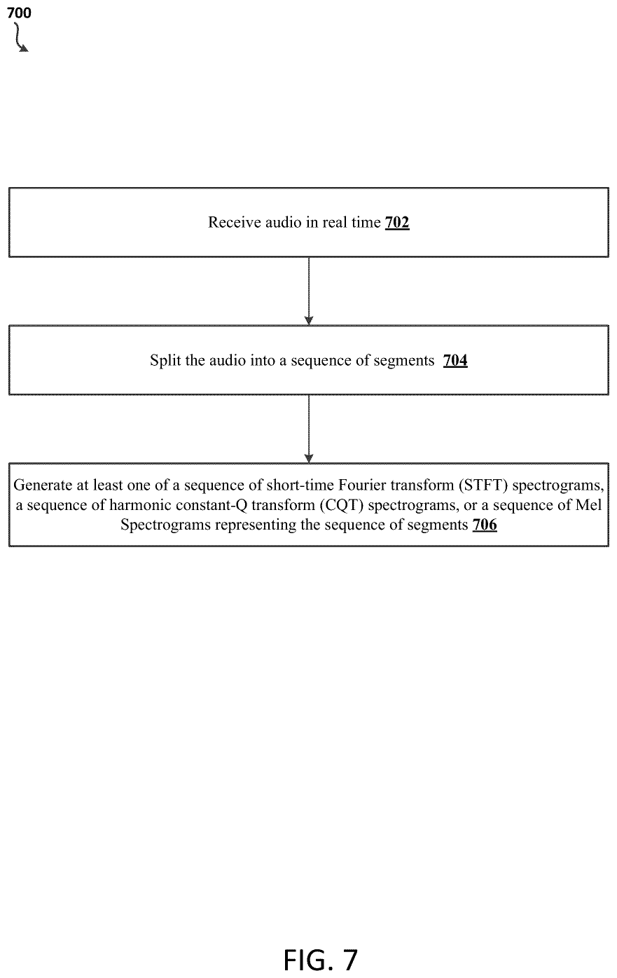

FIG. 7 illustrates an example process 700 performed by a system (e.g., system 100). The system 100 may perform the process 700 for tracking beats and downbeats of human voices in real time. Although depicted as a sequence of operations in FIG. 7, those of ordinary skill in the art will appreciate that various embodiments may add, remove, reorder, or modify the depicted operations.

At 702, audio may be received. The audio may comprise human voice audio. The audio may be received in real time. The audio may comprise a human singing voice. At 704, the audio may be split into a sequence of segments. Each segment may comprise any length (e.g., duration) of audio. For example, each segment may comprise two, three, four, five, six, seven, eight, nine, ten etc. seconds of the audio. At 706, a sequence of audio features corresponding to the sequence of segments of the audio may be extracted. The sequence of audio features corresponding to the sequence of segments may be generated by generating a sequence of short-time Fourier transform (STFT) spectrograms corresponding to (e.g., representative of) the sequence of segments of the audio. Each of the STFT spectrograms in the sequence may correspond to (e.g., represent) a particular segment of the audio. Alternatively, the sequence of audio features corresponding to the sequence of segments may be generated by generating a sequence of harmonic constant-Q transform (CQT) spectrograms corresponding to the sequence of segments of the audio. Each of the harmonic CQT spectrograms in the sequence may correspond to a particular segment of the audio 101. Alternatively, the sequence of audio features corresponding to the sequence of segments may be generated by generating a sequence of Mel Spectrograms corresponding to the sequence of segments of the audio. Each of the Mel Spectrograms in the sequence may correspond to a particular segment of the audio.

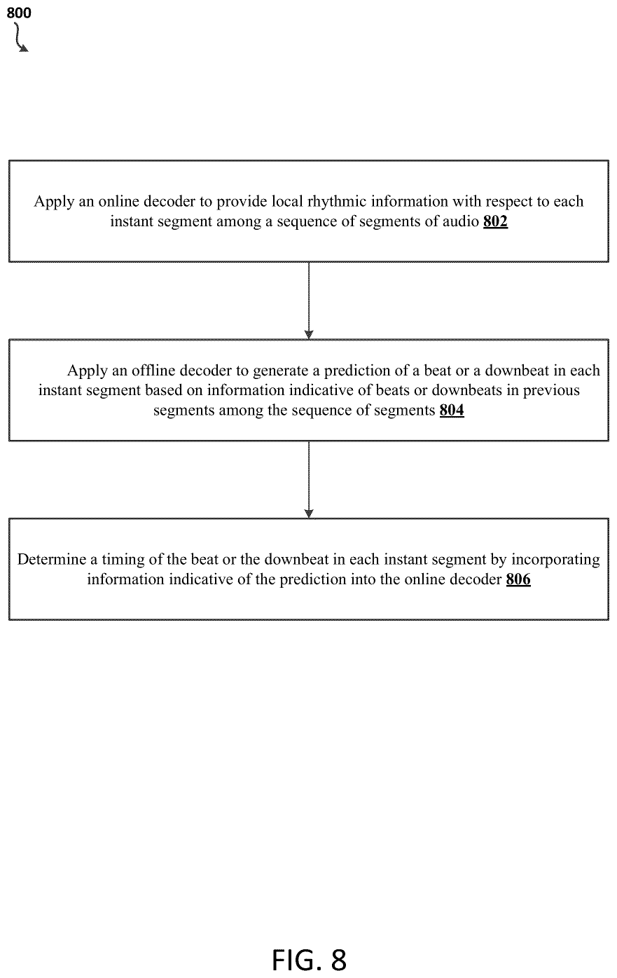

FIG. 8 illustrates an example process 800 performed by a system (e.g., system 100). The system 100 may perform the process 800 for tracking beats and downbeats of human voices in real time. Although depicted as a sequence of operations in FIG. 8, those of ordinary skill in the art will appreciate that various embodiments may add, remove, reorder, or modify the depicted operations.

Audio may be received. The audio may comprise human voice audio. The audio may be received in real time. The audio may comprise a human singing voice. The audio may be split into a sequence of segments. Each segment may comprise any length (e.g., duration) of audio. For example, each segment may comprise two, three, four, five, six, seven, eight, nine, ten etc. seconds of the audio. A sequence of audio features representing the sequence of segments of the audio may be extracted. The extracted sequence of audio features representing the sequence of segments of the audio may be sent to or input into one or more causal models. A continuous sequence of activations may be generated in real time by a causal model. The continuous sequence of activations may be indicative of probabilities of beats or downbeats occurring in the sequence of segments of the audio. At 802, an online decoder (e.g., the online decoder 108) may be applied. The online decoder may be applied to provide local rhythmic information with respect to each instant segment among the sequence of segments of audio (e.g., the audio 101). The online decoder may generate the local rhythmic information associated with a particular segment, such as the instant segment, based only the activation corresponding to that segment. As the online decoder only considers local prediction, it may be more robust to local rhythmic fluctuations or changes. This may be helpful for tracking beats and downbeats of human voices in real time as humans may not sing consistently or well in a few regions.

At 804, an offline decoder may be applied. The offline decoder (e.g., the offline decoder 106) may be applied to generate a prediction of a beat or a downbeat in each instant segment based on information indicative of beats or downbeats in previous segments among the sequence of segments. At 806, a timing of the beat or the downbeat in each instant segment may be determined. The timing of the beat or the downbeat in each instant segment may be determined by incorporating information indicative of the prediction from the offline decoder into the online decoder. Information indicative of the prediction may be incorporated into the online decoder. Given a period parameter T, the offline decoder may be applied every T seconds to the past data (e.g., all activations in the sequence of activations from the beginning to the present time step). The historical beat/downbeat timestamps may be used by the offline decoder to extrapolate the next upcoming beats/downbeats. When the time steps of the upcoming beats/downbeats arrive, the offline decoder may inject some particles at the beat/downbeat states to inform the online decoder about the offline extrapolations. If the particle swarm locates in some offbeat states but the offline inference made by the offline decoder suggests a beat/downbeat onset, adding the extra particles can help correct the online inference made by the online decoder.

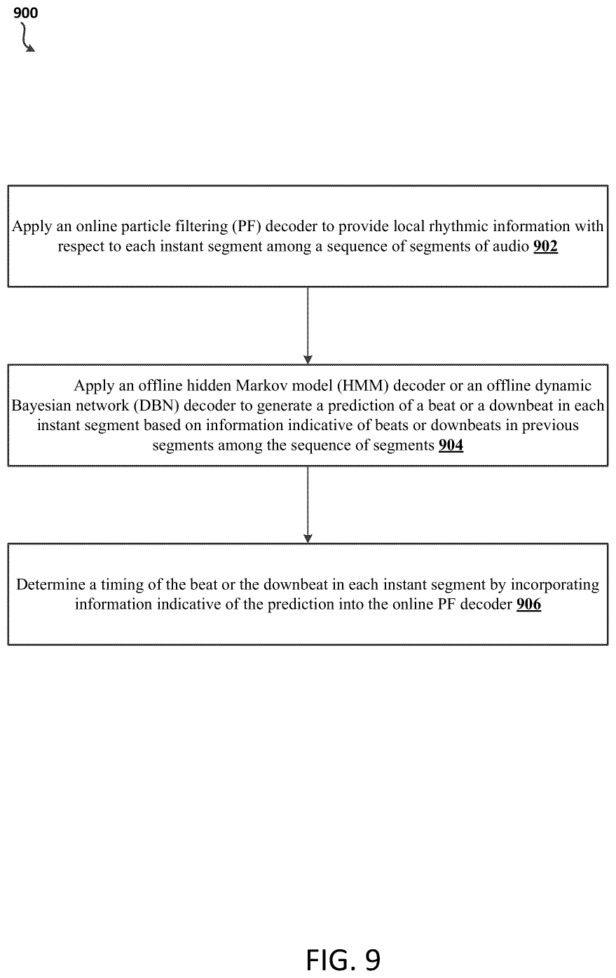

FIG. 9 illustrates an example process 900 performed by a system (e.g., system 100). The system 100 may perform the process 900 for tracking beats and downbeats of human voices in real time. Although depicted as a sequence of operations in FIG. 9, those of ordinary skill in the art will appreciate that various embodiments may add, remove, reorder, or modify the depicted operations.

Audio may be received. The audio may comprise human voice audio. The audio may be received in real time. The audio may comprise a human singing voice. The audio may be split into a sequence of segments. Each segment may comprise any length (e.g., duration) of audio. For example, each segment may comprise two, three, four, five, six, seven, eight, nine, ten etc. seconds of the audio. A sequence of audio features representing the sequence of segments of the audio may be extracted. The extracted sequence of audio features representing the sequence of segments of the audio may be sent to or input into one or more causal models. A continuous sequence of activations may be generated in real time by a causal model. The continuous sequence of activations may be indicative of probabilities of beats or downbeats occurring in the sequence of segments of the audio.

At 902, an online particle filtering (PF) decoder may be applied. The online PF decoder may be applied to provide local rhythmic information with respect to each instant segment among the sequence of segments of audio. The online decoder may generate the local rhythmic information associated with a particular segment, such as the instant segment, based only the activation corresponding to that segment. As the online decoder only considers local prediction, it may be more robust to local rhythmic fluctuations or changes. This may be helpful for tracking beats and downbeats of human voices in real time as humans may not sing consistently or well in a few regions. The online PF decoder may be configured to perform a cascade of two-stage Monte Carlo particle filtering. One stage may be to generate local rhythmic information for the beat tracking and the other stage to generate local rhythmic information for the downbeat tracking. However, instead of using a fixed number of particles, as seen with conventional particle filtering techniques, the online PF decoder may perform a dynamic particle filtering technique. The dynamic particle filtering technique may leverage a variable number of particles, with the number depending on the circumstance.

At 904, an offline hidden Markov model (HMM) decoder or an offline dynamic Bayesian network (DBN) decoder may be applied. The offline hidden Markov model (HMM) decoder or the offline dynamic Bayesian network (DBN) decoder may be applied to generate a prediction of a beat or a downbeat in each instant segment based on information indicative of beats or downbeats in previous segments among the sequence of segments.

At 906, a timing of the beat or the downbeat in each instant segment may be determined. The timing of the beat or the downbeat in each instant segment may be determined by incorporating information indicative of the prediction from the offline HMM or DBN decoder into the online PF decoder. Information indicative of the prediction may be incorporated into the online PF decoder. Given a period parameter T, the offline decoder may be applied every T seconds to the past data (e.g., all activations in the sequence of activations from the beginning to the present time step). The historical beat/downbeat timestamps may be used by the offline decoder to extrapolate the next upcoming beats/downbeats. When the time steps of the upcoming beats/downbeats arrive, the offline decoder may inject some particles at the beat/downbeat states to inform the online decoder about the offline extrapolations. If the particle swarm locates in some offbeat states but the offline inference made by the offline decoder suggests a beat/downbeat onset, adding the extra particles can help correct the online inference made by the online decoder.

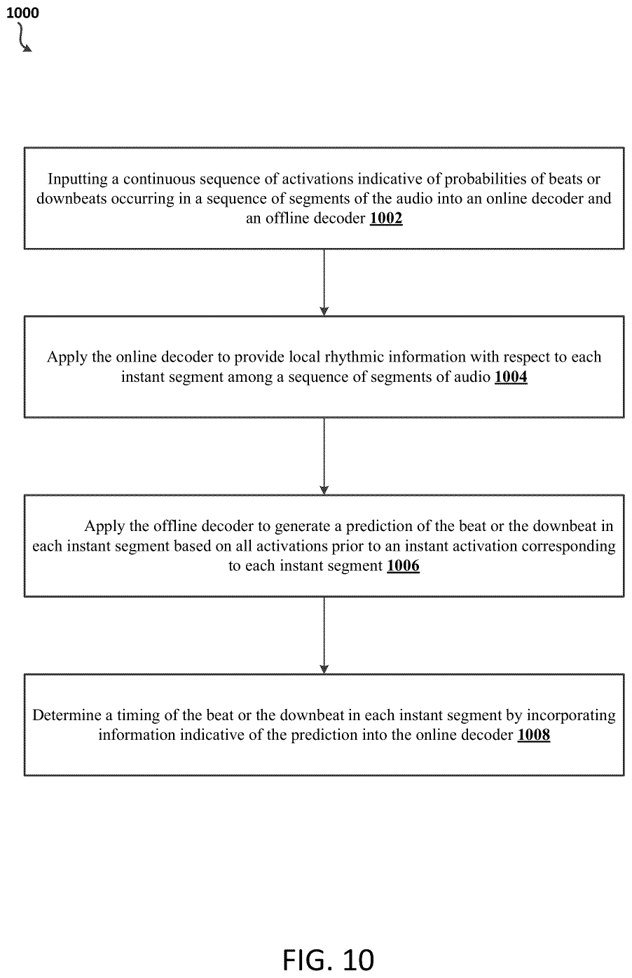

FIG. 10 illustrates an example process 1000 performed by a system (e.g., system 100). The system 100 may perform the process 1000 for tracking beats and downbeats of human voices in real time. Although depicted as a sequence of operations in FIG. 10, those of ordinary skill in the art will appreciate that various embodiments may add, remove, reorder, or modify the depicted operations.

Audio may be received. The audio may comprise human voice audio. The audio may be received in real time. The audio may comprise a human singing voice. The audio may be split into a sequence of segments. Each segment may comprise any length (e.g., duration) of audio. For example, each segment may comprise two, three, four, five, six, seven, eight, nine, ten etc. seconds of the audio. A sequence of audio features corresponding to the sequence of segments of the audio may be extracted. A causal model(s) may receive the extracted sequence of audio features corresponding to the sequence of segments of the audio. The causal model(s) may comprise any machine learning model with casual mechanisms.

The machine learning model may generate a sequence of activations based on the extracted sequence of audio features corresponding to the sequence of segments of the audio. The causal model(s) may generate the sequence of activations in real time. The sequence of activations may be a continuous sequence of activations. The sequence of activations may be indicative of probabilities of beats or downbeats occurring in the sequence of segments. Each activation in the sequence of activations may correspond to a particular segment in the sequence of segments of the audio. Each activation in the sequence of activations may indicate the probability of beats and/or downbeats occurring at each time frame in the corresponding segment.

At 1002, the continuous sequence of activations indicative of probabilities of beats or downbeats occurring in a sequence of segments of the audio may be input into an online decoder and an offline decoder. At 1004, the online decoder may be applied. The online decoder may be applied to provide local rhythmic information with respect to each instant segment among the sequence of segments of audio. The online decoder may generate the local rhythmic information associated with a particular segment, such as the instant segment, based only the activation corresponding to that segment. As the online decoder only considers local prediction, it may be more robust to local rhythmic fluctuations or changes. This may be helpful for tracking beats and downbeats of human voices in real time as humans may not sing consistently or well in a few regions.

At 1006, the offline decoder may be applied. The offline decoder may be applied to generate a prediction of the beat or the downbeat in each instant segment based on all activations prior to an instant activation corresponding to each instant segment. At 1008, a timing of the beat or the downbeat in each instant segment may be determined. The timing of the beat or the downbeat in each instant segment may be determined by incorporating information indicative of the prediction into the online decoder. The information indicative of the prediction from the offline decoder may be incorporated into the online decoder. Given a period parameter T, the offline decoder may be applied every T seconds to the past data (e.g., all activations in the sequence of activations from the beginning to the present time step). The historical beat/downbeat timestamps may be used by the offline decoder to extrapolate the next upcoming beats/downbeats. When the time steps of the upcoming beats/downbeats arrive, the offline decoder may inject some particles at the beat/downbeat states to inform the online decoder about the offline extrapolations. If the particle swarm locates in some offbeat states but the offline inference made by the offline decoder suggests a beat/downbeat onset, adding the extra particles can help correct the online inference made by the online decoder.

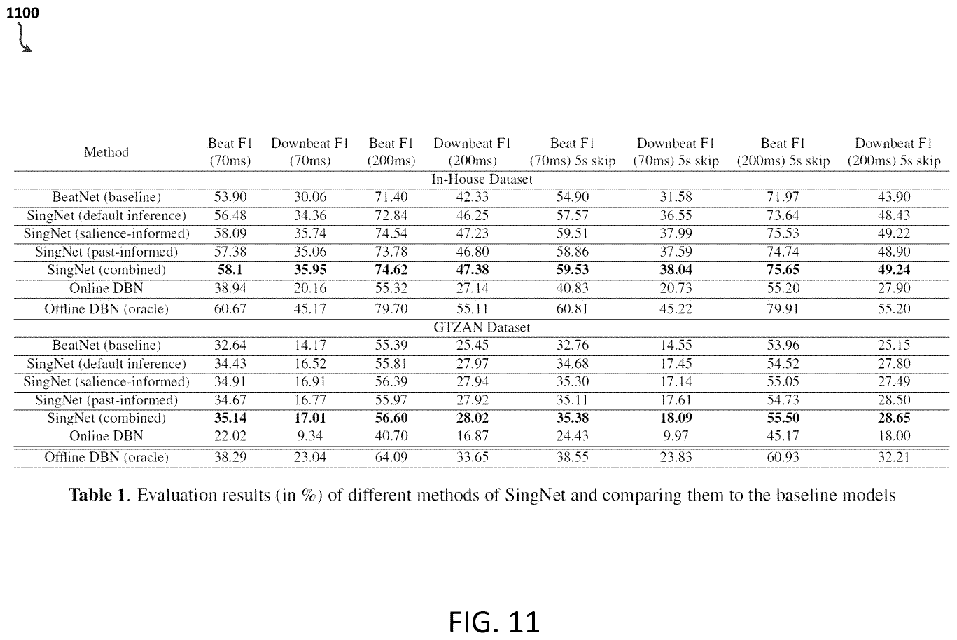

FIG. 11 depicts a table 1100. The table 1100 shows the evaluation results for different methods. The online, real time beat and downbeat tracking method for human voices described herein is referred to as the “SingNet (combined)” method on the table 1100. The training, validation and test sets remain the same across all of the methods. For each test set, the results of a baseline BeatNet system, which is trained on singing stems and uses the default particle filtering, are presented. The model size of the recurrent part of the CRNN module used in BeatNet (e.g., 2 unidirectional LSTM layers, each has 150 hidden cells) is smaller than that of SingNet. For SingNet, there is one variant using the default particle filtering and three using the proposed dynamic particle filtering with different methods. The “Online DBN” method uses the extrapolated results from an offline DBN applied every 6 seconds on total historical data for the causal uses. “Offline DBN” refers to an oracle system that applies the offline DBN on the entire data, assuming it can access the future signal. As shown in the table 1100, SingNet with dynamic particle filtering outperforms that using default particle filtering, and among the variants, the SingNet (combined) method performs the best in all cases. The “Online DBN” method results in the worst performance, since the extrapolations are not responsive to instant rhythmic fluctuations.

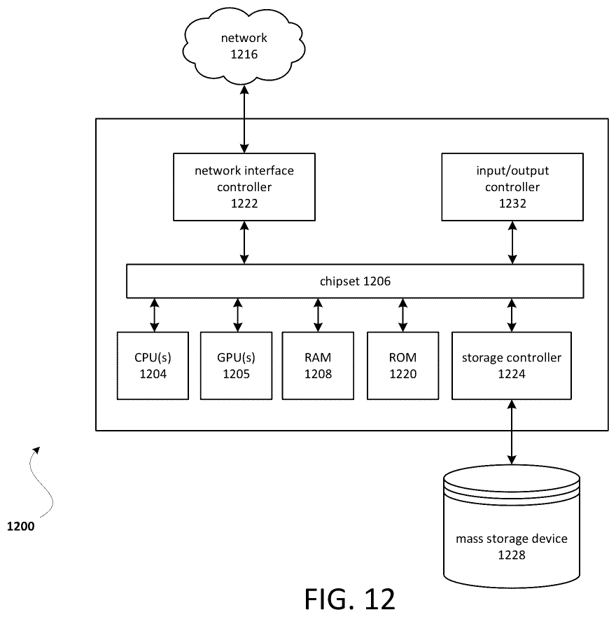

FIG. 12 illustrates a computing device that may be used in various aspects, such as the services, networks, modules, and/or devices depicted in FIG. 1. With regard to the example architecture of FIG. 1, any or all of the components may each be implemented by one or more instance of a computing device 1200 of FIG. 12. The computer architecture shown in FIG. 12 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1200 may include a baseboard, or “motherboard,” which is a printed circuit board to which a multitude of components or devices may be connected by way of a system bus or other electrical communication paths. One or more central processing units (CPUs) 1204 may operate in conjunction with a chipset 1206. The CPU(s) 1204 may be standard programmable processors that perform arithmetic and logical operations necessary for the operation of the computing device 1200.

The CPU(s) 1204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1204 may be augmented with or replaced by other processing units, such as GPU(s) 1205. The GPU(s) 1205 may comprise processing units specialized for but not necessarily limited to highly parallel computations, such as graphics and other visualization-related processing.

A chipset 1206 may provide an interface between the CPU(s) 1204 and the remainder of the components and devices on the baseboard. The chipset 1206 may provide an interface to a random-access memory (RAM) 1208 used as the main memory in the computing device 1200. The chipset 1206 may further provide an interface to a computer-readable storage medium, such as a read-only memory (ROM) 1220 or non-volatile RAM (NVRAM) (not shown), for storing basic routines that may help to start up the computing device 1200 and to transfer information between the various components and devices. ROM 1220 or NVRAM may also store other software components necessary for the operation of the computing device 1200 in accordance with the aspects described herein.

The computing device 1200 may operate in a networked environment using logical connections to remote computing nodes and computer systems through local area network (LAN). The chipset 1206 may include functionality for providing network connectivity through a network interface controller (NIC) 1222, such as a gigabit Ethernet adapter. A NIC 1222 may be capable of connecting the computing device 1200 to other computing nodes over a network 1216. It should be appreciated that multiple NICs 1222 may be present in the computing device 1200, connecting the computing device to other types of networks and remote computer systems.

The computing device 1200 may be connected to a mass storage device 1228 that provides non-volatile storage for the computer. The mass storage device 1228 may store system programs, application programs, other program modules, and data, which have been described in greater detail herein. The mass storage device 1228 may be connected to the computing device 1200 through a storage controller 1224 connected to the chipset 1206. The mass storage device 1228 may consist of one or more physical storage units. The mass storage device 1228 may comprise a management component 1210. A storage controller 1224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1200 may store data on the mass storage device 1228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1228 is characterized as primary or secondary storage and the like.

For example, the computing device 1200 may store information to the mass storage device 1228 by issuing instructions through a storage controller 1224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1200 may further read information from the mass storage device 1228 by detecting the physical states or characteristics of one or more particular locations within the physical storage units.

In addition to the mass storage device 1228 described above, the computing device 1200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1200.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1228 depicted in FIG. 12, may store an operating system utilized to control the operation of the computing device 1200. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1228 may store other system or application programs and data utilized by the computing device 1200.

The mass storage device 1228 or other computer-readable storage media may also be encoded with computer-executable instructions, which, when loaded into the computing device 1200, transforms the computing device from a general-purpose computing system into a special-purpose computer capable of implementing the aspects described herein. These computer-executable instructions transform the computing device 1200 by specifying how the CPU(s) 1204 transition between states, as described above. The computing device 1200 may have access to computer-readable storage media storing computer-executable instructions, which, when executed by the computing device 1200, may perform the methods described herein.

A computing device, such as the computing device 1200 depicted in FIG. 12, may also include an input/output controller 1232 for receiving and processing input from a number of input devices, such as a keyboard, a mouse, a touchpad, a touch screen, an electronic stylus, or other type of input device. Similarly, an input/output controller 1232 may provide output to a display, such as a computer monitor, a flat-panel display, a digital projector, a printer, a plotter, or other type of output device. It will be appreciated that the computing device 1200 may not include all of the components shown in FIG. 12, may include other components that are not explicitly shown in FIG. 12, or may utilize an architecture completely different than that shown in FIG. 12.

As described herein, a computing device may be a physical computing device, such as the computing device 1200 of FIG. 12. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of tracking beats and downbeats of audio in real time, comprising:
receiving audio in real time;
splitting the audio into a sequence of segments;
extracting a sequence of audio features corresponding to the sequence of segments of the audio;
generating in real time a continuous sequence of activations indicative of probabilities of beats or downbeats occurring in the sequence of segments of the audio using a machine learning model with causal mechanisms, wherein the machine learning model is pre-trained to generate beat or downbeat activations based on audio features; and
determining timings of the beats or the downbeats occurring in the sequence of segments of the audio based on the continuous sequence of activations by fusing local rhythmic information with respect to each instant segment among the sequence of segments of the audio with information indicative of beats or downbeats in previous segments among the sequence of segments.

2. The method of claim 1, further comprising:
applying an online decoder to provide the local rhythmic information with respect to each instant segment among the sequence of segments of the audio; and
applying an offline decoder to generate a prediction of a beat or a downbeat in each instant segment based on information indicative of beats or downbeats in previous segments among the sequence of segments.

3. The method of claim 2, further comprising:
determining a timing of the beat or the downbeat in each instant segment by incorporating information indicative of the prediction into the online decoder.

4. The method of claim 2, wherein the continuous sequence of activations is input into the online decoder and the offline decoder.

5. The method of claim 2, further comprising:
generating the prediction of the beat or the downbeat in each instant segment based on all activations prior to an instant activation corresponding to each instant segment.

6. The method of claim 2, wherein the online decoder comprises a particle filtering (PF) decoder.

7. The method of claim 2, wherein the offline decoder comprises a hidden Markov model (HMM) decoder or a dynamic Bayesian network (DBN) decoder.

8. The method of claim 1, wherein the extracting a sequence of audio features corresponding to the sequence of segments of the audio further comprises:
generating at least one of a sequence of short-time Fourier transform (STFT) spectrograms, a sequence of harmonic constant-Q transform (CQT) spectrograms, or a sequence of Mel Spectrograms representing the sequence of segments.

9. A system of extracting a melody, comprising:
at least one processor; and
at least one memory communicatively coupled to the at least one processor and comprising computer-readable instructions that upon execution by the at least one processor cause the at least one processor to perform operations comprising:
receiving audio in real time;
splitting the audio into a sequence of segments;
extracting a sequence of audio features corresponding to the sequence of segments of the audio;
generating in real time a continuous sequence of activations indicative of probabilities of beats or downbeats occurring in the sequence of segments of the audio using a machine learning model with causal mechanisms, wherein the machine learning model is pre-trained to generate beat or downbeat activations based on audio features; and
determining timings of the beats or the downbeats occurring in the sequence of segments of the audio based on the continuous sequence of activations by fusing local rhythmic information with respect to each instant segment among the sequence of segments of the audio with information indicative of beats or downbeats in previous segments among the sequence of segments.

10. The system of claim 9, the operations further comprising:
applying an online decoder to provide the local rhythmic information with respect to each instant segment among the sequence of segments of the audio; and
applying an offline decoder to generate a prediction of a beat or a downbeat in each instant segment based on information indicative of beats or downbeats in previous segments among the sequence of segments.

11. The system of claim 10, the operations further comprising:
determining a timing of the beat or the downbeat in each instant segment by incorporating information indicative of the prediction into the online decoder.

12. The system of claim 10, wherein the continuous sequence of activations is input into the online decoder and the offline decoder.

13. The system of claim 10, the operations further comprising:
generating the prediction of the beat or the downbeat in each instant segment based on all activations prior to an instant activation corresponding to each instant segment.

14. The system of claim 10, wherein the online decoder comprises a particle filtering (PF) decoder, and wherein the offline decoder comprises a hidden Markov model (HMM) decoder or a dynamic Bayesian network (DBN) decoder.

15. A non-transitory computer-readable storage medium, storing computer-readable instructions that upon execution by a processor cause the processor to implement operations comprising:
receiving audio in real time;
splitting the audio into a sequence of segments;
extracting a sequence of audio features corresponding to the sequence of segments of the audio;
generating in real time a continuous sequence of activations indicative of probabilities of beats or downbeats occurring in the sequence of segments of the audio using a machine learning model with causal mechanisms, wherein the machine learning model is pre-trained to generate beat or downbeat activations based on audio features; and
determining timings of the beats or the downbeats occurring in the sequence of segments of the audio based on the continuous sequence of activations by fusing local rhythmic information with respect to each instant segment among the sequence of segments of the audio with information indicative of beats or downbeats in previous segments among the sequence of segments.

16. The non-transitory computer-readable storage medium of claim 15, the operations further comprising:
applying an online decoder to provide the local rhythmic information with respect to each instant segment among the sequence of segments of the audio; and
applying an offline decoder to generate a prediction of a beat or a downbeat in each instant segment based on information indicative of beats or downbeats in previous segments among the sequence of segments.

17. The non-transitory computer-readable storage medium of claim 16, the operations further comprising:
determining a timing of the beat or the downbeat in each instant segment by incorporating information indicative of the prediction into the online decoder.

18. The non-transitory computer-readable storage medium of claim 16, wherein the continuous sequence of activations is input into the online decoder and the offline decoder.

19. The non-transitory computer-readable storage medium of claim 16, the operations further comprising:
generating the prediction of the beat or the downbeat in each instant segment based on all activations prior to an instant activation corresponding to each instant segment.

20. The non-transitory computer-readable storage medium of claim 16, wherein the online decoder comprises a particle filtering (PF) decoder, and wherein the offline decoder comprises a hidden Markov model (HMM) decoder or a dynamic Bayesian network (DBN) decoder.
